(19) United States
(12) Patent Application Publication
(10) Pub. No.: US 2013/0300823 A1
(43) Pub. Date: Nov. 14, 2013

(54) STEREO EFFECT ENHANCEMENT SYSTEMS AND METHODS

(71) Applicants: Jiun-Sian Chu, Kaohsiung City (TW); Tsu-Lin Chang, New Taipei City (TW)

(72) Inventors: Jiun-Sian Chu, Kaohsiung City (TW); Tsu-Lin Chang, New Taipei City (TW)

(21) Appl. No.: 13/468,187

(22) Filed: May 10, 2012

(51) Int. Cl. H04N 13/00; H04N 13/04

(52) U.S. Cl. 348/43; 348/54; 348/E13.002; 348/E13.059

(57) ABSTRACT

In one embodiment, a stereo effect enhancement method, comprising: receiving a first multimedia stream and a second multimedia stream, the second multimedia stream comprising a second frame at a second depth and the first multimedia stream comprising a first frame at a first depth that is to be presented within the second frame; adjusting a difference between the first and second depths by reducing parallax between the first and second frames; and adding a border around the first frame, wherein the adjusting and adding provide a more visually satisfying presentation of stereoscopic content corresponding to the first and second frames, the receiving, adjusting, and adding performed by a processor.

### TECHNICAL FIELD

The present disclosure is generally related to stereoscopic systems.

### BACKGROUND

Stereoscopic technology (e.g., 3D) and devices have gained increasing popularity among users. For instance, many multimedia entertainment systems implement stereoscopic user interfaces to immerse the user in a more realistic user experience. However, certain stereoscopic views may cause user discomfort (e.g., eye fatigue, confusion, etc.) and/or dissatisfaction, such as where there are multiple media presented on a display during a given instance in time (e.g., picture-in-picture, or PIP, or side-by-side formats (e.g., horizontally adjacent or vertically adjacent)).

### SUMMARY

In one embodiment, a stereo effect enhancement method, comprising: receiving a first multimedia stream and a second multimedia stream, the second multimedia stream comprising a second frame at a second depth and the first multimedia stream comprising a first frame at a first depth that is to be presented within the second frame; adjusting a difference between the first and second depths by reducing parallax between the first and second frames; and adding a border around the first frame, wherein the adjusting and adding provide a more visually satisfying presentation of stereoscopic content corresponding to the first and second frames, the receiving, adjusting, and adding performed by a processor.

In another embodiment, a stereo effect enhancement method, comprising: presenting plural multimedia streams to plural portions of a display screen, wherein a first of the multimedia streams is in a first portion consisting of a picture-in-picture format, at least one of the plural multimedia streams comprising stereoscopic content; analyzing a depth at an edge of the first portion relative to a second portion of the plural portions; responsive to the analysis: adjusting by a processor a depth of the first portion, the second portion, or a combination of both, wherein the adjusting comprises reducing parallax between the stereoscopic content of the first and second portions; and adding by the processor a border around the first portion.

In another embodiment, a stereo effect enhancement system, comprising: a memory comprising logic; and a processor configured by the logic to: present plural multimedia streams to plural portions of a display screen, wherein a first of the multimedia streams is in a first portion consisting of a picture-in-picture format, the plural multimedia streams comprising stereoscopic content; analyze a depth at an edge of the first portion relative to a second portion of the plural portions; adjust a depth of the first portion, the second portion, or a combination of both by reducing parallax between the stereoscopic content of the first and second portions; and add a border around the first portion.

In another embodiment, a stereo effect enhancement method, comprising: receiving a first multimedia stream and a second multimedia stream, the second multimedia stream comprising a second frame at a second depth and the first multimedia stream comprising a first frame at a first depth that is to be presented adjacent to the second frame; adjusting a difference between the first and second depths by reducing parallax between the first and second frames; and adding a border around the first frame, wherein the adjusting and adding provide a more visually satisfying presentation of stereoscopic content corresponding to the first and second frames, the receiving, adjusting, and adding performed by a processor.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates an example multi-stream, stereoscopic video presentation that an embodiment of a stereo effect enhancement system operates on to improve visual satisfaction.

FIG. 2 is a schematic diagram that illustrates an example embodiment of a stereo effect enhancement method employing depth adjustment to a multi-stream, stereoscopic video presentation.

FIG. 3 is a schematic diagram that illustrates an example embodiment of a stereo effect enhancement method employing border enhancement to a multi-stream, stereoscopic video presentation.

FIG. 4 is a schematic diagram that illustrates an example embodiment of a stereo effect enhancement method employing border modification to a multi-stream, stereoscopic video presentation.

FIG. 5 is a schematic diagram that illustrates an example multi-stream, stereoscopic video presentation that an embodiment of a stereo effect enhancement system operates on to improve visual satisfaction.

FIG. 6 is a schematic diagram that illustrates an example embodiment of a stereo effect enhancement method employing depth adjustment to a multi-stream, stereoscopic video presentation.

FIG. 7 is a schematic diagram that illustrates an example embodiment of a stereo effect enhancement method employing border enhancement to a multi-stream, stereoscopic video presentation.

FIG. 8 is a schematic diagram that illustrates an example embodiment of a stereo effect enhancement method employing border modification to a multi-stream, stereoscopic video presentation.

FIG. 9 is a block diagram that illustrates an example embodiment of a stereo effect enhancement system.

FIG. 10 is a flow diagram of an example embodiment of a stereo effect enhancement method.

FIG. 11 is a flow diagram of an example embodiment of a stereo effect enhancement method.

FIG. 12 is a flow diagram of an example embodiment of a stereo effect enhancement method.

### DETAILED DESCRIPTION

Disclosed herein are certain embodiments of an invention that comprises a stereo effect enhancement system and method that enhances and separates a stereo effect of multimedia by adjusting the depth along an edge of an embedded or adjacent portion of a display screen that presents picture-in-picture or adjacent frames. For instance, in one picture-in-picture format embodiment, the stereo effect enhancement system provides a main, stereoscopic video frame sequence (e.g., video stream) for presentation on a viewable portion of a display screen, and also provides another video stream (also with stereoscopic content) for presentation in a smaller viewable portion of the display screen. The stereo effect enhancement system analyzes an edge of the smaller portion and adjusts the depth within the smaller portion, outside the smaller portion, or a combination of both. By adjusting the depth (e.g., to reduce parallax between the frames of the picture-in-picture presentation and the main presentation), the stereoscopic content in both the smaller and large frames appears more harmonious, resulting in a more satisfying video presentation to a user. In some embodiments, a similar manner of processing is implemented for side-by-side format embodiments (e.g., side-by-side corresponding to horizontally or vertically adjacent frames).

In contrast, showing multimedia streams in two portions within a picture (e.g., embedding one of the pictures within another) often appears inharmonious due to the difference in depths, causing a less-than-desirable viewer experience. For instance, the difference in depths may cause eye fatigue, dizziness, confusion, among other affects. By adjusting the depths between frames (e.g., pictures and frames herein used interchangeably, with the understanding that similar processing on fields such as in interlaced video applies similarly to progressive frames), the viewer's discomfort is eliminated or significantly mitigated, and the stereo effect is improved.

Having broadly summarized certain features of stereo effect enhancement systems and methods of the present disclosure, reference will now be made in detail to the description of the disclosure as illustrated in the drawings. While the disclosure is described in connection with these drawings, there is no intent to limit the disclosure to an embodiment or embodiments disclosed herein. For instance, though described in the context of video streams, it should be appreciated that additional and/or other forms of media, such as stereoscopic graphics, are contemplated to be within the scope of the disclosure. In other words, though certain examples disclosed herein use video streams to illustrate the various features of one or more disclosed embodiments, it should be appreciated that in general, multimedia streams are contemplated to be within the scope of the disclosure, the multimedia streams including one or a combination of video streams and graphics streams. Although the description identifies or describes specifics of one or more embodiments, such specifics are not necessarily part of every embodiment, nor are all various stated advantages associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

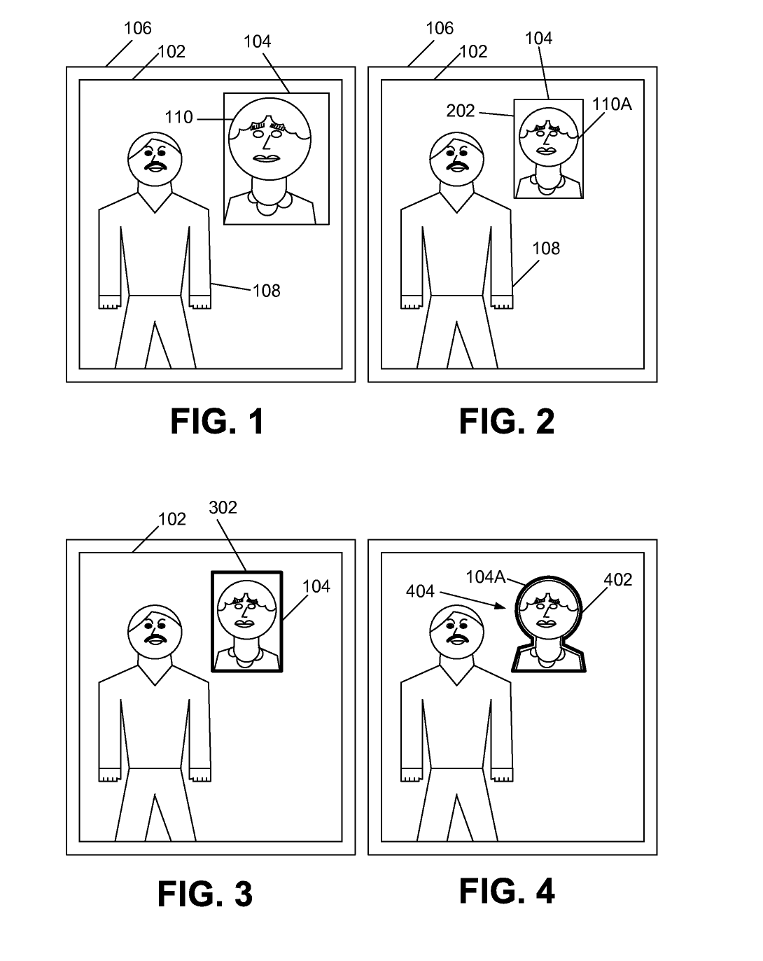

Attention is directed to FIG. 1, which illustrates a main frame 102 and an embedded frame 104 that is in picture-in-picture (PIP) format presented on a display screen 106. It should be appreciated that the depicted frames 102 and 104 are captured images at a given instance of time, and that the frames presented on the display screen 106 vary over time according to the sequence of presented frames in a video presentation. As indicated above, though described in the context of video, stereoscopic content in the context of graphics processing similarly applies. The main frame 102 comprises one or more stereoscopic objects of a captured image, such as a person 108 at a given snapshot in time as depicted in FIG. 1. The embedded frame 104 comprises one or more stereoscopic objects of a captured image, such as another person 110 at a given snapshot in time. The main frame 102 occupies a larger portion of the screen 106 than the embedded frame 104. For instance, the embedded frame 104 may be overlapped on top of a portion of the main frame 102. In addition, the main frame 102 may be part of a scene of a video frame sequence (e.g., video stream) corresponding to stereoscopic content, such as from a reconstructed elementary program stream of a movie or other media content. The embedded frame 104 may also be part of the same scene, but with a different view. Alternatively, the embedded frame 104 may be part of a video frame sequence for another movie or media content. In either case, the embedded frame 104 and the main frame 102 occupy the display screen 106 at the same time, but consume a different amount of screen real estate.

For purposes of illustration, the difference in size of the depicted objects (e.g., persons 108 and 110) of each frame 102 and 104 is used to illustrate a difference in scene depth. For instance, the face of the person 110 presented in the embedded frame 104 is depicted as larger in size than the face of the person 108 presented in the main frame 102, the larger size reflecting that the person 110 is perceived as being located closer to a viewer than the person 108 in the main frame 102. In some implementations, the person 110 in the embedded frame 104 may be perceived as farther from the viewer than the person 108. Practically speaking, the actual size of the objects in the embedded frame 104 does not change (absent employment of a zooming feature or the like), but rather, the perception of depth that the viewer experiences between the embedded frame 104 and the main frame 102. Such differences in depth may cause viewer discomfort and/or a perceived unsatisfactory stereoscopic presentation. To address any inharmonious presentation of the multiple video streams, an embodiment of a stereo effect enhancement system employs one or more methods to adjust the depth or the perception of depth.

Referring to FIG. 2, shown is one example embodiment of a stereo effect enhancement method that adjusts for differences in depth. In the example depicted in FIG. 2, the stereoscopic object (i.e., the person 110A) in the embedded frame 104 appears farther from the viewer than as shown in FIG. 1, as noted by the change in size between the person 110 in FIG. 1 and the same person 110A in FIG. 2. In particular, certain embodiments of a stereo effect enhancement system analyze an edge 202 of the embedded frame 104 (e.g., the portion of the screen 106 in which the embedded frame 104 is presented), and adjusts the depth of the person 110A relative to stereoscopic objects of the main frame 102, such as the person 108. Such an adjustment may be performed by analyzing depth maps of both frames 102 and 104, and adjusting the parallax present between the person 108 and the person 110 (FIG. 1), the result as illustrated in FIG. 2 by the similarity in size between the persons 108 and 110A. In some implementations, the adjustment may comprise an adjustment of positive parallax or negative parallax of the stereoscopic content, and/or by shifting a left eye and/or right eye image. For instance, depth information of left and right-eye images may be obtained, and the depth information is adjusted to provide a new left-eye image according to the right-eye image and the adjusted depth information (or vice versa). Though the depicted example in FIG. 2 contemplates an adjustment of the depth in the embedded frame 104 to make the depth closer to (e.g., equal to) the depth of the stereoscopic content of the main frame 102, it should be appreciated within the context of the present disclosure that adjustment may include adjustment of the depth of stereoscopic content in the main frame 102, embedded frame 104, or a combination of both. In addition, though shown with a single embedded frame 104, it should be appreciated that some embodiments may comprise plural embedded frames presented simultaneously with stereoscopic content in the main frame 102.

In some embodiments, the stereo effect enhancement system may employ measures additional to the depth adjustment described above to make the presentation of the stereoscopic content of the main frame 102 and embedded frame 104 more realistic. Referring to FIG. 3, shown is the depth-adjusted frames 102 and 104, with the addition of a border 302 surrounding the embedded frame 104. Certain embodiments of the stereo effect enhancement system may modify certain properties of the border 302. For instance, the thickness (e.g., width) may be adjusted to enhance the stereo effect. Another example property that may be modified is the translucence, such as to ease the transition between the background of the main frame 102 and the background of the embedded frame 104. Another example property of the border 302 that may be modified is the shape, as described in association with FIG. 4.

Directing attention to FIG. 4, shown is the result of modifying the shape of the border 302 in FIG. 3 from the rectangular format to an irregular-shaped polygon depicted for the border 402 in FIG. 4, resulting in a modified embedded frame 104A. In one embodiment, the stereo effect enhancement system may achieve the irregular-shaped border 402 by clearing the background of the embedded frame 104 (FIG. 3), revealing a previously obscured portion 404 of the main frame 102.

Note that although certain embodiments of a stereo effect enhancement system are illustrated in FIGS. 1-4 in the context of functionality in conjunction with a display screen presentation, it should be appreciated in the context of the present disclosure that one or more of such functionality may be achieved transparently to the user, such as via a real-time or substantially real-time process that occurs preliminarily to the presentation of each frame (102 and 104) in a reconstructed frame sequence. For instance, certain embodiments of the stereo effect enhancement system may receive the reconstructed frames from a decoder and/or associated memory residing within a computing device. In some embodiments, one or more of said stereoscopic enhancement functionality may be performed in conjunction with user input, such as according to an editing process.

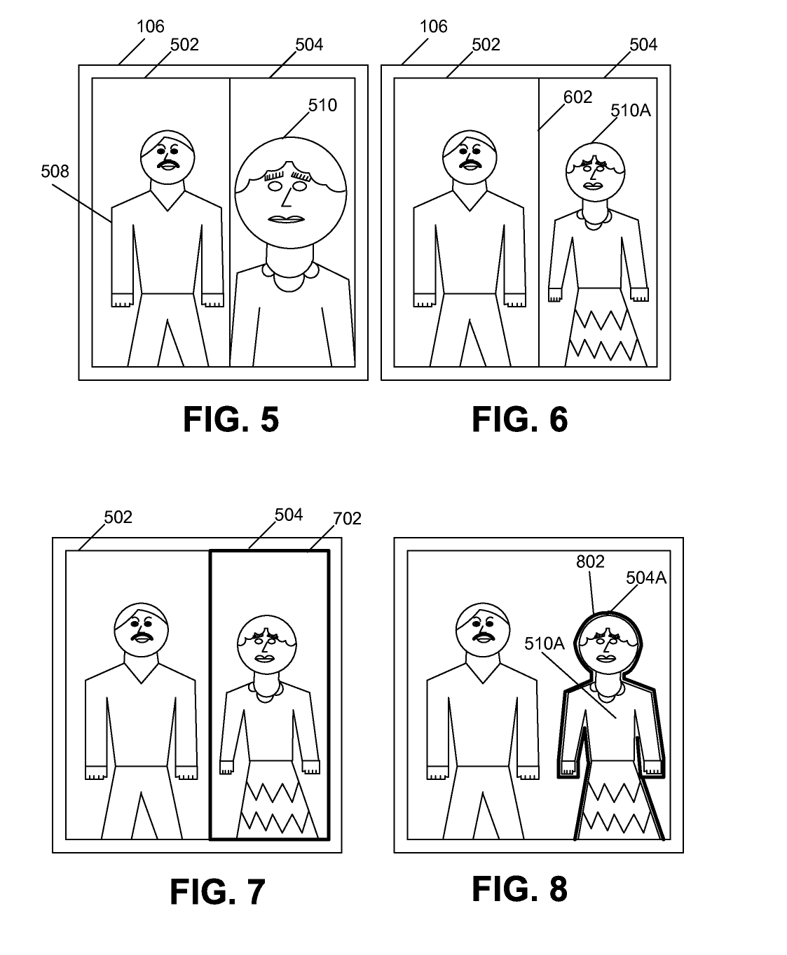

Having described certain embodiments of a stereo effect enhancement system where multimedia streams are simultaneously presented on a display in picture-in-picture format, reference is now made to FIGS. 5-8, which illustrate one or more embodiments of a stereo effect enhancement system where multimedia streams are simultaneously presented in side-by-side format. Though FIGS. 5-8 illustrate two, horizontally adjacent frames presented simultaneously (e.g., in a split-window format), similar principles apply (and hence contemplated to be within the scope of the disclosure) where the frames are presented in vertical side-by-side format (e.g., one frame on top of the other), and/or where more than two adjacent frames are presented simultaneously, or any combination of the above configurations in some embodiments. Referring to FIG. 5, a main frame 502 and an adjacent frame 504 (e.g., horizontally adjacent to main frame 502) are presented (e.g., simultaneously) on the display screen 106. It should be appreciated that the depicted frames 502 and 504 are captured images at a given instance of time, and that the frames presented on the display screen 106 vary over time according to the sequence of presented frames in a video presentation. As indicated above, though described in the context of video, stereoscopic content in the context of graphics processing similarly applies.

The main frame 502 comprises one or more stereoscopic objects of a captured image, such as a person 508 at a given snapshot in time as depicted in FIG. 5. The adjacent frame 504 comprises one or more stereoscopic objects of a captured image, such as another person 510 at a given snapshot in time. The main frame 502 occupies a similarly-sized area or portion (e.g., split in half on the screen 106 in this example) of the screen 106 as the adjacent frame 504, though not limited to similarity in size. In addition, the main frame 502 may be part of a scene of a video frame sequence (e.g., video stream) corresponding to stereoscopic content, such as from a reconstructed elementary program stream of a movie or other media content. The adjacent frame 504 may also be part of the same scene, but with a different view. Alternatively, the adjacent frame 504 may be part of a video frame sequence for another movie or media content. In either case, the adjacent frame 504 and the main frame 502 occupy the display screen 106 at the same time, and may consume the same or different amount of screen real estate.

For purposes of illustration, as is similar for the examples depicted in FIGS. 1-4, the difference in size of the depicted objects (e.g., persons 508 and 510) of each frame 502 and 504 is used to illustrate a difference in scene depth. For instance, the face and body of the person 510 presented in the adjacent frame 504 is depicted as larger in size than the face and body of the person 508 presented in the main frame 502, the larger size reflecting that the person 510 is perceived as being located closer to a viewer than the person 508 in the main frame 502. In some implementations, the person 510 in the adjacent frame 504 may be perceived as farther from the viewer than the person 508. Practically speaking, the actual size of the objects in the adjacent frame 504 does not change (absent employment of a zooming feature or the like), but rather, the perception of depth that the viewer experiences between the adjacent frame 504 and the main frame 502. Such differences in depth may cause viewer discomfort and/or a perceived unsatisfactory stereoscopic presentation. To address any inharmonious presentation of the multiple video streams, an embodiment of a stereo effect enhancement system employs one or more methods to adjust the depth or the perception of depth.

Referring to FIG. 6, shown is one example embodiment of a stereo effect enhancement method that adjusts for differences in depth. In the example depicted in FIG. 6, the stereoscopic object (i.e., the person 510A) in the adjacent frame 504 appears farther from the viewer than as shown in FIG. 5, as noted by the change in size between the person 510 in FIG. 5 and the same person 510A in FIG. 6. In particular, certain embodiments of a stereo effect enhancement system analyze an edge 602 of the adjacent frame 504 (e.g., the portion of the screen 106 in which the adjacent frame 504 is presented), and adjusts the depth of the person 510A relative to stereoscopic objects of the main frame 502, such as the person 508. Such an adjustment may be performed by analyzing depth maps of both frames 502 and 504, and adjusting the parallax present between the person 508 and the person 510 (FIG. 5), the result as illustrated in FIG. 6 by the similarity in size between the persons 508 and 510A. In some implementations, the adjustment may comprise an adjustment of positive parallax or negative parallax of the stereoscopic content, and/or by shifting a left eye and/or right eye image.

For instance, depth information of left and right-eye images may be obtained, and the depth information is adjusted to provide a new left-eye image according to the right-eye image and the adjusted depth information (or vice versa). Though the depicted example in FIG. 6 contemplates an adjustment of the depth in the adjacent frame 504 to make the depth closer to (e.g., equal to) the depth of the stereoscopic content of the main frame 502, it should be appreciated within the context of the present disclosure that adjustment may include adjustment of the depth of stereoscopic content in the main frame 502, adjacent frame 504, or a combination of both. In addition, though shown with a single adjacent frame 504, it should be appreciated that some embodiments may comprise plural adjacent frame presented simultaneously with stereoscopic content in the main frame 502, as explained above.

In some embodiments, the stereo effect enhancement system may employ measures additional to the depth adjustment described above to make the presentation of the stereoscopic content of the main frame 502 and adjacent frame 504 more realistic. Referring to FIG. 7, shown is the depth-adjusted frames 502 and 504, with the addition of a border 702 surrounding the adjacent frame 504. Certain embodiments of the stereo effect enhancement system may modify certain properties of the border 702. For instance, the thickness (e.g., width) may be adjusted to enhance the stereo effect. Another example property that may be modified is the translucence, such as to ease the transition between the background of the main frame 502 and the background of the adjacent frame 504. Another example property of the border 702 that may be modified is the shape, as described in association with FIG. 8.

Directing attention to FIG. 8, shown is the result of modifying the shape of the border 702 in FIG. 7 from the rectangular format to an irregular-shaped polygon (e.g., substantially outlining the person 510A) depicted for the border 802 in FIG. 8, resulting in a modified adjacent frame 504A.

Note that although certain embodiments of a stereo effect enhancement system are illustrated in FIGS. 5-8 in the context of functionality in conjunction with a display screen presentation, it should be appreciated in the context of the present disclosure that one or more of such functionality may be achieved transparently to the user, such as via a real-time or substantially real-time process that occurs preliminarily to the presentation of each frame (502 and 504) in a reconstructed frame sequence. For instance, certain embodiments of the stereo effect enhancement system may receive the reconstructed frames from a decoder and/or associated memory residing within a computing device. In some embodiments, one or more of said stereoscopic enhancement functionality may be performed in conjunction with user input, such as according to an editing process. Note that in some embodiments, a combination of split-screen and picture-in-picture format may be employed, with similar methods for depth adjustment employed.

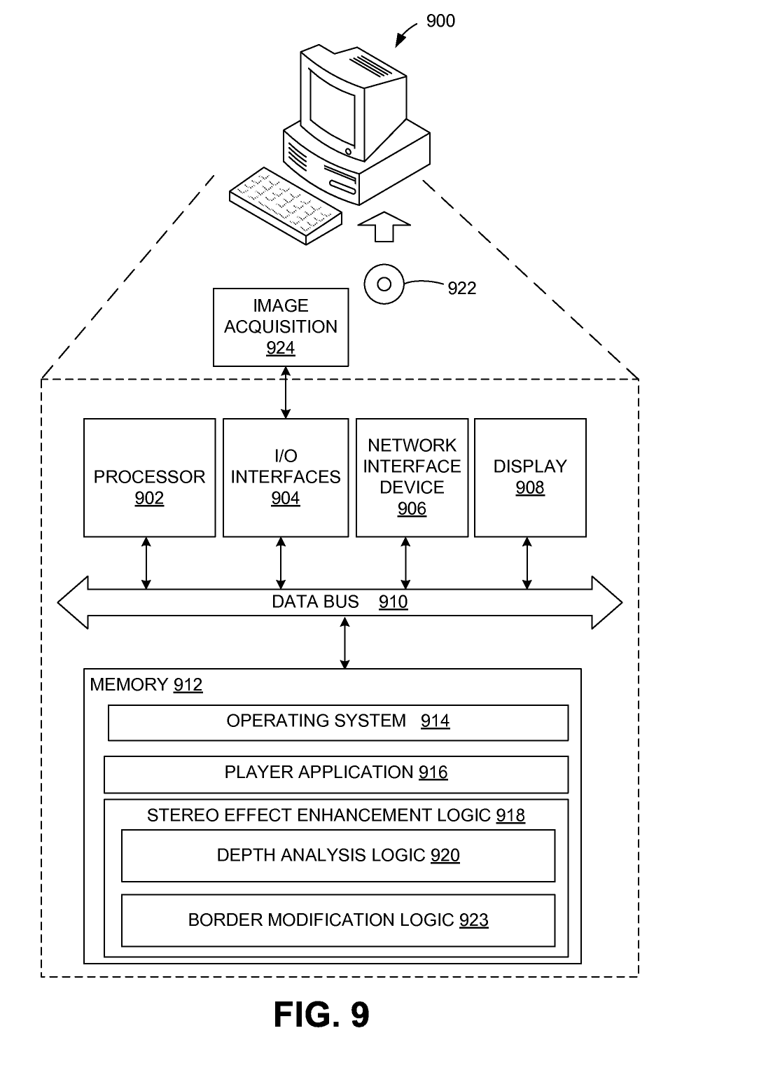

Having described example operations of certain embodiments of a stereo effect enhancement system, attention is directed to FIG. 9, which illustrates an embodiment of stereo effect enhancement system as embodied in a computing system 900. A stereo effect enhancement system may be embodied in the entirety of the computing system 900 depicted in FIG. 9, or as a subset thereof in some embodiments. The example computing system 900 is shown as including a personal computer, though it should be appreciated within the context of the present disclosure that the computing system 900 may comprise any one of a plurality of computing devices, including a dedicated player appliance, set-top box, laptop, computer workstation, cellular phone, personal digital assistant (PDA), handheld or pen based computer, embedded appliance, or other communication (wired or wireless) device. In some embodiments, the stereo effect enhancement system may be implemented on a network device (also referred to herein as a computing system), similar to the computing system 900, located upstream of the computing system 900, such as a server, router, gateway, etc., or implemented with similar functionality distributed among plural devices (e.g., in a server device and the computing device). An upstream network device may be configured with similar components, and hence discussion of the same is omitted for brevity.

The computing system 900 may, for instance, comprise one or more processors 902, one or more input/output (I/O) interfaces 904, a network interface device 906, and a display 908 connected across a data bus 910. The computing system 900 may further comprise a memory 912 that includes an operating system 914 and application specific software (e.g., software logic, also referred to as executable code), such as a player application 916 in the case of implementing player functionality for the playback of media content, such as video, graphics, and/or audio (e.g., movies, music, games, etc.). In some embodiments, the player application 916 may be implemented as a software program configured to read and play back content residing on a disc 922 (or from other high definition video sources) according to the specifications defined by standards such as the Blu-ray Disc format specification, HD-DVD, etc. In some embodiments, the player application 916 may comprise decoding logic, or some embodiments may include decoding logic separate from the player application 916.

The memory 912 comprises, among other logic (e.g., software), stereo effect enhancement logic 918, which includes in one embodiment, depth analysis logic 920 and border modification logic 923. Though shown as separate modules from the player application 916, the stereo effect enhancement logic 918 may comprise modules that are packaged differently, such as being configured as a part of the player application 916 in some embodiments. In some embodiments, the depth analysis logic 920 and border modification logic 923 may be combined into a single software module, or further distributed among additional modules. The depth analysis logic 920 performs depth analysis along one or more edges of the embedded frame 104 (or adjacent frame 504) and the main frame 102 (or main frame 502). In one embodiment, the depth analysis logic 920 constructs a depth map of plural pixels located within the frames 102 (502) and 104 (504), as is known technology and hence the details are omitted here for brevity. Further, the depth analysis logic 920 determines the parallax between one or more stereoscopic objects of the two frames 102 (502) and 104 (504), and adjusts the difference in depth (e.g., parallax adjustment) so that the difference in depth is zero or a predetermined value close to zero.

The border modification logic 923 adds a discernible border around the embedded frame 104 (or adjacent frame 504), typically a rectangular border though not limited to such geometries. The border modification logic 923 further adjusts one or more properties of the border, including translucence, thickness (e.g., width), color, texture (e.g., metal, wood, etc.), and/or shape (e.g., irregular polygon versus rectangle). For instance, with regard to color, the color may have a gradient effect, or the color may have a high contrast color (compared to adjacent multimedia colors). In some embodiments, the border may resemble a photo frame. In some embodiments, the border may possess a stereoscopic effect (e.g., have depth information). For instance, the depth information of the border may have a corresponding depth value(s) that may be between the depth value of the main frame stereoscopic objects and/or background and the depth value of the embedded frame stereoscopic objects and/or background. In some embodiments, the stereoscopic effect of the border provides a gradient stereoscopic effect. In some embodiments, the border modification logic 923 may be omitted.

The processor 902 may include any custom made or commercially available processor, a central processing unit (CPU) or an auxiliary processor among several processors associated with the computing system 900, a semiconductor based microprocessor (in the form of a microchip), one or more ASICs, a plurality of suitably configured digital logic gates, and other well-known electrical configurations comprising discrete elements both individually and in various combinations to coordinate the overall operation of the computing system.

The memory 912 may include any one of a combination of volatile memory elements (e.g., random-access memory (RAM, such as DRAM, and SRAM, etc.)) and nonvolatile memory elements (e.g., ROM, hard drive, tape, CDROM, etc.). The memory 912 typically comprises the native operating system 914, one or more native applications, emulation systems, or emulated applications for any of a variety of operating systems and/or emulated hardware platforms, emulated operating systems, etc. For example, the applications may include application specific software stored on a computer readable medium (e.g., memory, persistent storage, etc.) for execution by the processor 902 and may include the stereo effect enhancement logic 918, depth analysis logic 920, and border modification logic 923. One of ordinary skill in the art will appreciate that the memory 912 may, and typically will, comprise other components which have been omitted for purposes of brevity, or in some embodiments, may omit certain components.

Input/output interfaces 904 provide any number of interfaces for the input and output of data. For example, where the computing system 900 comprises a personal computer, these components may interface with a user input device, which may be a body part of a viewer (e.g., hand), keyboard, a mouse, or voice activated mechanism. Where the computing system 900 comprises a handheld device (e.g., PDA, mobile telephone), these components may interface with function keys or buttons, a touch sensitive screen, a stylus, body part, microphone, etc. The input/output interfaces 904 may further include one or more disc drives (e.g., optical disc drives, magnetic disc drives) to enable playback of multimedia content residing on the computer readable medium 922.

The network interface device 906 comprises various components used to transmit and/or receive data over a network environment. By way of example, the network interface device 906 may include a device that can communicate with both inputs and outputs, for instance, a modulator/demodulator (e.g., a modem), wireless (e.g., radio frequency (RF)) transceiver, a telephonic interface, a bridge, a router, network card, etc. The computing system 900 may further comprise mass storage (not shown). For some embodiments, the mass storage may include a data structure (e.g., database) to store image and/or data files. In some embodiments, the image and date files may be located in a remote storage device (e.g., network storage).

The display 908 may comprise a computer monitor or a plasma screen for a PC or a liquid crystal display (LCD) on a hand held device, head-mount device, or other computing device. In some embodiments, the display 908 may be separate from the computing system 900, and in some embodiments, integrated in the computing device. The display 908 may include the screen 106 described previously.

In the context of this disclosure, a “computer-readable medium” stores one or more programs and data for use by or in connection with the instruction execution system, apparatus, or device. The computer readable medium is non-transitory, and may be, for example, but not limited to, an electronic, magnetic, optical, electromagnetic, infrared, or semiconductor system, apparatus, or device. More specific examples (a non-exhaustive list) of the computer-readable medium may include, in addition to those set forth above, the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), and a portable compact disc read-only memory (CDROM) (optical).

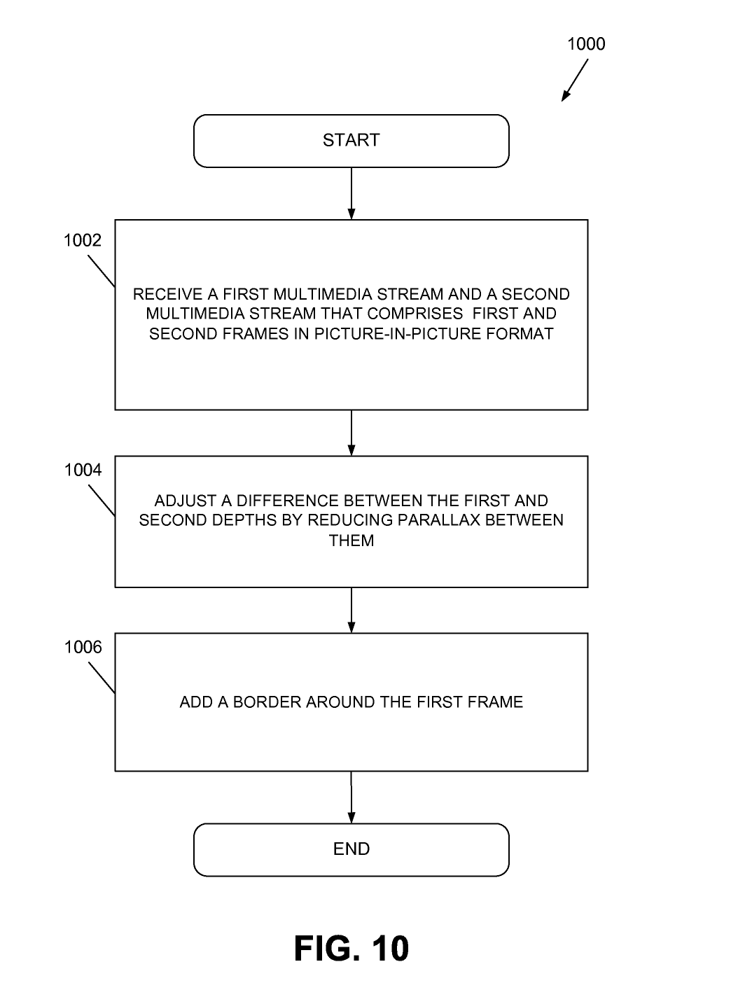

Having provided a detailed description of certain embodiments of stereo effect enhancement systems and methods, it should be appreciated that one embodiment of a stereo effect enhancement method 1000, implemented by the processor 902 in the computing system 900 and depicted in FIG. 10, comprises receiving a first multimedia stream and a second multimedia stream comprising first and second frames in picture-in-picture format (1002). For instance, the second multimedia stream may comprise a second frame at a second depth and the first multimedia stream may comprise a first frame at a first depth that is to be presented within the second frame. The method 1000 further comprises adjusting a difference between first and second depths of the first and second frames by reducing parallax between them (e.g., between the first and second frames) (1004). The method 1000 further comprises adding a border around the first frame (1006). The adjusting and adding provide a more visually satisfying presentation of stereoscopic content corresponding to the first and second frames.

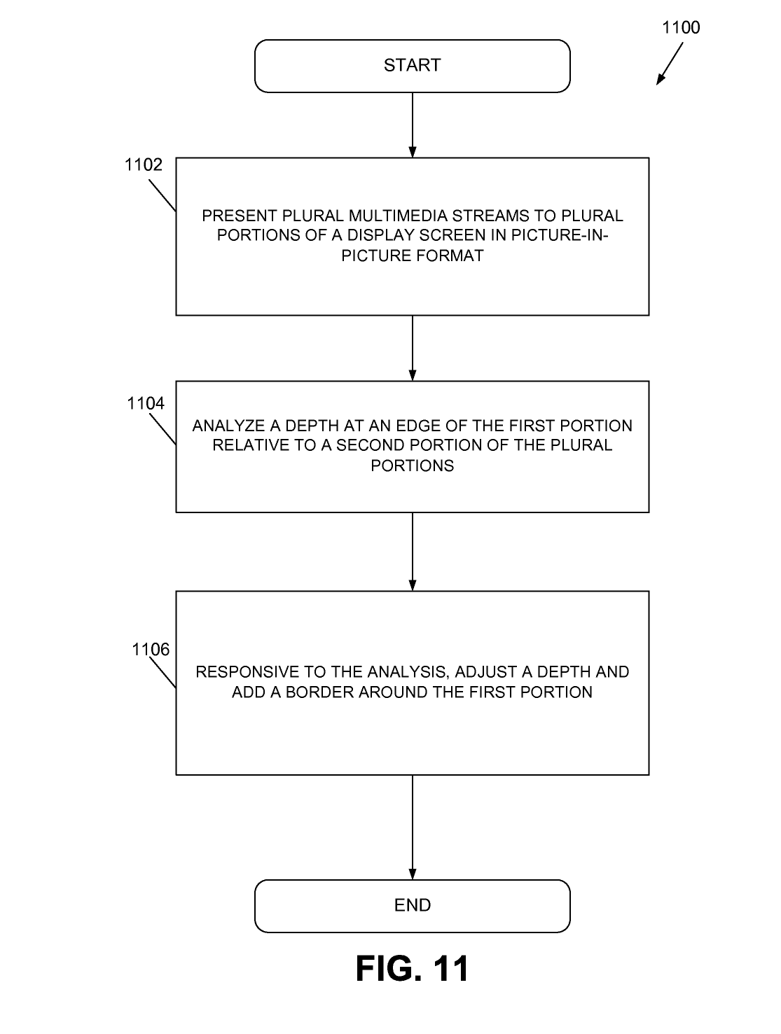

In view of the foregoing disclosure, it should be appreciated that another embodiment of a stereo effect enhancement method 1100, implemented by the processor 902 in the computing system 900 and depicted in FIG. 11, comprises presenting plural multimedia streams to plural portions of a display screen in picture-in-picture format (1102). For instance, a first of the multimedia streams is in a first portion consisting of a picture-in-picture format, and at least one of the plural multimedia streams comprise stereoscopic content. The method 1100 further comprises analyzing a depth at an edge of the first portion relative to a second portion of the plural portions (1104). Responsive to the analysis, the method 1100 further comprises: adjusting a depth of the first portion, the second portion, or a combination of both, wherein the adjusting comprises reducing parallax between the stereoscopic content of the first and second portions; and adding a border around the first portion (1106).

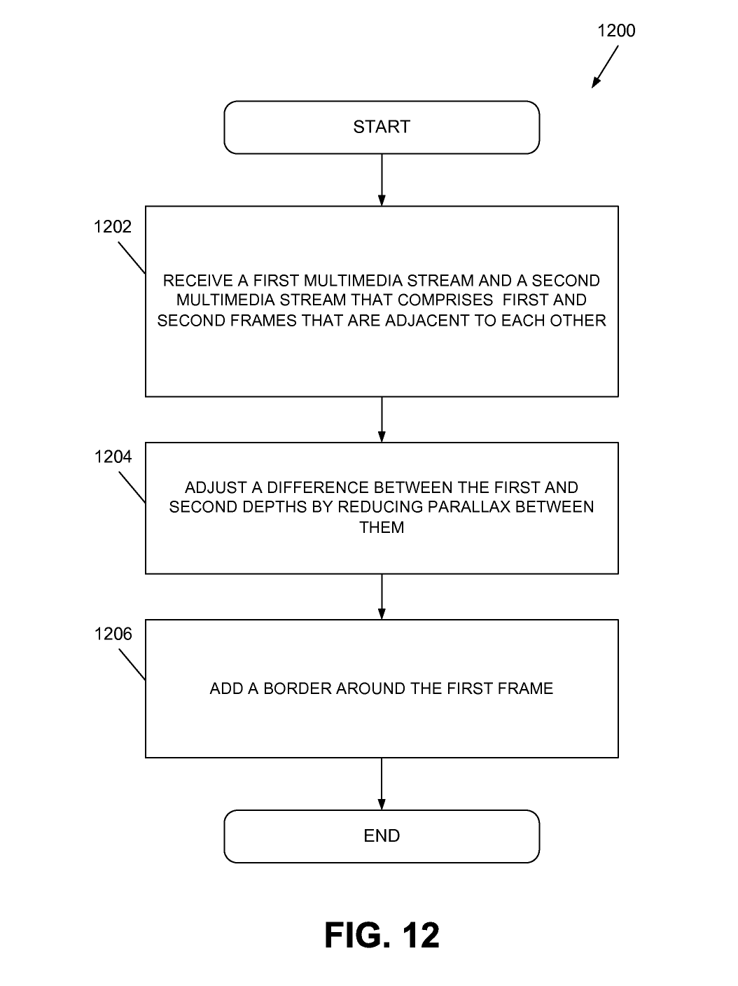

In view of the foregoing disclosure, it should be appreciated that another embodiment of a stereo effect enhancement method 1200, implemented by the processor 902 in the computing system 900 and depicted in FIG. 12, comprises receiving a first multimedia stream and a second multimedia stream comprising first and second frames that are adjacent to each other (1202). For instance, the second multimedia stream may comprise a second frame at a second depth and the first multimedia stream may comprise a first frame at a first depth that is to be presented adjacent to the second frame. The method 1200 further comprises adjusting a difference between first and second depths of the first and second frames by reducing parallax between them (e.g., between the first and second frames) (1204). The method 1200 further comprises adding a border around the first frame (1206). The adjusting and adding provide a more visually satisfying presentation of stereoscopic content corresponding to the first and second frames.

Any process descriptions or blocks in flow diagrams should be understood as representing modules, segments, or portions of code which include one or more executable instructions for implementing specific logical functions or steps in the process, and alternate implementations are included within the scope of the embodiments of the present disclosure in which functions may be executed out of order from that shown or discussed, including substantially concurrently or in reverse order, and/or with one or more functions omitted in some embodiments, depending on the functionality involved, as would be understood by those reasonably skilled in the art of the present disclosure. Also, though certain architectures are illustrated in the present disclosure, it should be appreciated that the methods described herein are not necessarily limited to the disclosed architectures.

In addition, though various delineations in software logic have been depicted in the accompanying figures and described in the present disclosure, it should be appreciated that one or more of the functions performed by the various logic described herein may be combined into fewer software modules and or distributed among a greater number. Further, though certain disclosed benefits/advantages inure to certain embodiments of certain stereo effect enhancement systems, it should be understood that not every embodiment necessarily provides every benefit/advantage.

In addition, the scope of certain embodiments of the present disclosure includes embodying the functionality of certain embodiments of stereo effect enhancement systems in logic embodied in hardware and/or software-configured mediums. For instance, though described in software configured mediums, it should be appreciated that one or more of the stereo effect enhancement system and method functionality described herein may be implemented in hardware or a combination of both hardware and software.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A stereo effect enhancement method, comprising:
receiving a first multimedia stream and a second multimedia stream, the second multimedia stream comprising a second frame at a second depth and the first multimedia stream comprising a first frame at a first depth that is to be presented within the second frame;
adjusting a difference between the first and second depths by reducing parallax between the first and second frames; and
adding a border around the first frame, wherein the adjusting and adding provide a more visually satisfying presentation of stereoscopic content corresponding to the first and second frames, the receiving, adjusting, and adding performed by a processor.

2. The method of claim 1, further comprising providing the first and second frames to a display device, the first frame comprising a picture-in-picture frame.

3. The method of claim 1, further comprising modifying properties of the border.

4. The method of claim 3, wherein the properties include translucence, border thickness, color, or texture, or a combination of two or more of the properties.

5. The method of claim 1, wherein the border resembles a photo frame.

6. The method of claim 1, wherein the border comprises depth information.

7. The method of claim 6, wherein the depth information of the border comprises a depth value that is between the depth value of the first frame and the depth value of the second frame.

8. The method of claim 1, further comprising generating a gradient stereoscopic effect based on a parallax-reduced depth change.

9. The method of claim 1, further comprising:
modifying the border from a rectangle to an irregular polygon; and
restoring portions of the second frame previously obscured by the rectangular first frame.

10. A stereo effect enhancement method, comprising:
presenting plural multimedia streams to plural portions of a display screen, wherein a first of the multimedia streams is in a first portion consisting of a picture-in-picture format, at least one of the plural multimedia streams comprising stereoscopic content;
analyzing a depth at an edge of the first portion relative to a second portion of the plural portions;
responsive to the analysis:
adjusting by a processor a depth of the first portion, the second portion, or a combination of both, wherein the adjusting comprises reducing parallax between the stereoscopic content of the first and second portions; and
adding by the processor a border around the first portion.

11. The method of claim 10, further comprising modifying properties of the border.

12. The method of claim 11, wherein the properties include translucence, border thickness, shape of the border, color, or texture, or a combination of two or more of the properties.

13. The method of claim 10, wherein the border resembles a photo frame.

14. The method of claim 10, wherein the border comprises depth information.

15. The method of claim 14, wherein the depth information of the border is between the depth value of the first portion and the depth value of the second portion

16. The method of claim 10, further comprising generating a gradient stereoscopic effect based on a parallax-reduced depth change.

17. The method of claim 10, further comprising restoring a background of the second portion responsive to changing the shape of the border from a rectangle to an irregular polygon.

18. A stereo effect enhancement system, comprising:
a memory comprising logic; and
a processor configured by the logic to:
present plural multimedia streams to plural portions of a display screen, wherein a first of the multimedia streams is in a first portion consisting of a picture-in-picture format, the plural multimedia streams comprising stereoscopic content;
analyze a depth at an edge of the first portion relative to a second portion of the plural portions;
adjust a depth of the first portion, the second portion, or a combination of both by reducing parallax between the stereoscopic content of the first and second portions; and
add a border around the first portion.

19. The system of claim 18, wherein the processor is further configured by the logic to modify properties of the border, wherein the properties include one or more of translucence, color, texture, border thickness, and a shape of the border.

20. The system of claim 18, wherein the processor is further configured by the logic to restore a background of the second portion responsive to changing a shape of the border from a rectangle to an irregular polygon.

21. A stereo effect enhancement method, comprising:
receiving a first multimedia stream and a second multimedia stream, the second multimedia stream comprising a second frame at a second depth and the first multimedia stream comprising a first frame at a first depth that is to be presented adjacent to the second frame;
adjusting a difference between the first and second depths by reducing parallax between the first and second frames; and
adding a border around the first frame, wherein the adjusting and adding provide a more visually satisfying presentation of stereoscopic content corresponding to the first and second frames, the receiving, adjusting, and adding performed by a processor.
